(19) United States
(12) Patent Application Publication
(10) Pub. No.: US 2026/0161614 A1
(43) Pub. Date: Jun. 11, 2026

(54) Decision aid method for an aircraft pilot, related electronic decision aid system and set of computer program products

(71) Applicant: THALES, Meudon (FR)

(72) Inventors: Thomak LEDUC, MERIGNAC (FR); Marc GATTI, MERIGNAC (FR); Jaime DIAZ-PINEDA, MERIGNAC (FR); Benoît LE BLANC, GRADIGNAN (FR)

(21) Appl. No.: 19/405,878

(22) Filed: Dec. 2, 2025

(30) Foreign Application Priority Data
Dec. 6, 2024 (FR) FR2413570

(51) Int. Cl. G06F 16/21; G06F 40/284; G06F 40/30

(52) U.S. Cl. CPC G06F 16/211; G06F 40/284; G06F 40/30

(57) ABSTRACT

A decision aid method for a pilot of an aircraft includes a generation phase, implemented prior to the aircraft flight and the obtaining of a plurality of pilot responses in the context of a transfer of responsibility. The generation phase further includes extracting data from the responses to form a set of taxons, and generating the structured database by classifying the taxons and determining a set of quantified importance indicator(s). The method further includes an interaction phase, implemented during the flight and including the determination and transmission to the pilot of determined data in the structured database based on a pilot request.

The present invention relates to a decision aid method for a pilot in an aircraft.

The present invention also relates to an electronic decision aid system and a set of associated computer program products.

In the field of aeronautics, pilots are regularly required to make decisions in a short period of time. To assist them in decision-making, aircraft cockpits traditionally include different electronic systems, such as flight computers, also called FMS (Flight Management System), as well as Human-Machine Interfaces (HMI) with which pilots are able to interact.

These systems are able to transmit various information to the aircraft pilot, for example, by continuously displaying the value of different parameters, such as altitude, external pressure, or fuel quantity.

However, when the pilot is faced with an unusual situation or one that deviates from their habits, they must first determine what information they need before consulting the associated parameters and deducing the actions to take.

This analysis requires valuable time from the aircraft pilot before taking any action. In some cases, this lost time is a risk to the smooth running of the flight, even to the safety of passengers in the most extreme cases.

Furthermore, in aircraft including at least two pilots, it is common for pilots to take turns during the flight when the journey is long (e.g., over 6 hours). In this case, during the change of pilot, the previous pilot must convey the current state of the flight situation to the future pilot. This task also takes considerable time since the previous pilot must provide a comprehensive overview to the next pilot of the relevant information for the continuity of the flight. Moreover, during this task, omissions can occur, or unnecessary information may also be transmitted.

The present invention aims to save this valuable time for the pilot(s), particularly to limit the risks of flight accidents.

To this end, the present invention relates to a decision aid method for a pilot of an aircraft, the method comprising a phase of generating a structured database implemented by an electronic generation device, and a phase of interaction between the structured database and the pilot, implemented by an electronic interaction device integrated into an aircraft cockpit,
the generation phase being implemented prior to the aircraft flight and comprising the following steps:
   obtaining a plurality of texts corresponding to pilot responses in the context of a transfer of responsibility, from one pilot to another, during a flight simulation of the aircraft,
   extracting data from the obtained texts to form a set of data, called taxons, each taxon comprising a word, or a set of words, related to a characteristic of the cockpit,
   generating the structured database by classifying the taxons in a predetermined database structure, and determining a set of quantified importance indicators for each taxon by comparing each taxon to the obtained texts,
the interaction phase being implemented during the aircraft flight and comprising the following steps:
   receiving a request from the pilot,
   determining the data from the structured database that is relevant to the request by comparing the request to the data in the structured database, transmitting the determined data to the pilot.

According to particular embodiments, the method comprises the following features, taken individually or in any technically feasible combinations:
the obtaining step comprises the following sub-steps:
   acquisition of audio tracks comprising the speech of pilots performing tasks on a simulator and to whom a list of questions is posed;
   conversion of each audio track into a respective text file;
the list of questions comprises a first group of questions related to the takeover of the cockpit by a pilot, and a second group of questions related to the transfer of the cockpit to another pilot;
the set of quantified importance indicator(s) comprises at least one relevance score whose value is based on the frequency of occurrence of said taxon in the texts, the relevance score being greater the more the corresponding taxon is presented as important in the obtained texts during the obtaining step;
the set of quantified importance indicator(s) for each taxon comprises:
   a frequency of occurrence of the taxon in a part of the obtained texts,
   a TF-IDF score of said taxon resulting from a vectorization of the taxon,
   the relevance score of the taxon, the relevance score of the taxon being calculated from the responses to the questions related to the transfer of the cockpit;
the second group of questions comprises:
   a first question asking the pilot for the information they would have liked to transmit,
   a second question asking the pilot for the information they would not have liked to transmit,
the relevance score of each taxon depending positively on the frequency of occurrence of said taxon in the response to the first question, and negatively on the frequency of occurrence of said taxon in the response to the second question;
the step of extracting terms from the texts comprises the following sub-steps:
   dividing each text into a plurality of smaller word sets compared to the text,
   parsing the word sets into tokens each comprising a smaller number of words than the word sets,
   for each token, reducing said token to a lemma comprising a semantic root of the word(s) of the token,
   selecting, among the formed lemmas, based on the frequency of occurrence of these lemmas among the texts from different pilots.
      the selected lemmas forming the set of data, called taxons;
the list of questions comprises a question asking the pilot to transmit the information they consider important for the transfer to the other pilot,
during the selection sub-step of the extraction step, the lemma taxons are further selected only among the lemmas from the response texts to said question;
the generation phase further comprises a filtering step, during which the taxons whose set of quantified importance indicator(s) do not meet a respective criterion are removed from the structured database.

The invention also relates to a set of computer program products comprising software instructions which, when executed by computers, implement a decision aid method as described above.

The invention also relates to an electronic pilot aid system for an aircraft, the system comprising a device for generating a structured database, and an interaction device between the structured database and the pilot, the electronic interaction device being integrated into an aircraft cockpit,
the generation device being configured to, prior to the aircraft flight:
   obtain a plurality of texts corresponding to pilot responses in the context of a transfer of responsibility, from one pilot to another, during a flight simulation of the aircraft,
   extract data from the obtained texts to form a set of data, called taxons, each taxon comprising a word, or a set of words, related to a characteristic of the cockpit,
   generate the structured database by classifying the taxons in a predetermined database structure, and determining a set of quantified importance indicator(s) for each taxon by comparing each taxon to the obtained texts,
the interaction device being configured to, during the aircraft flight:
   receive a request from the pilot,
   determine the data from the structured database that is relevant to the request by comparing the request to the data in the structured database,
   transmit the determined data to the pilot.

The invention will become clearer upon reading the following description, given solely by way of non-limiting example, and made with reference to the drawings wherein:

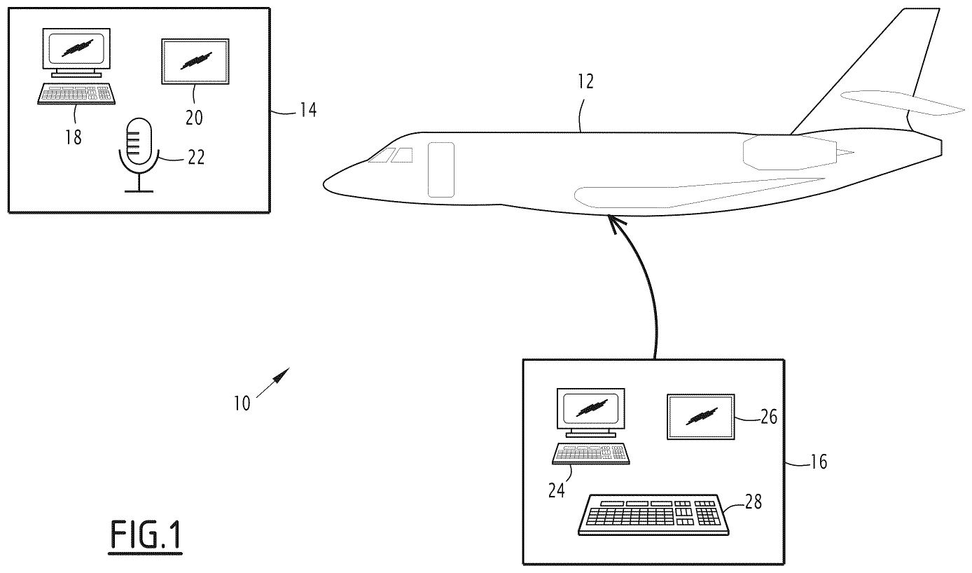

FIG. 1 is a schematic representation of a pilot aid system according to the invention;

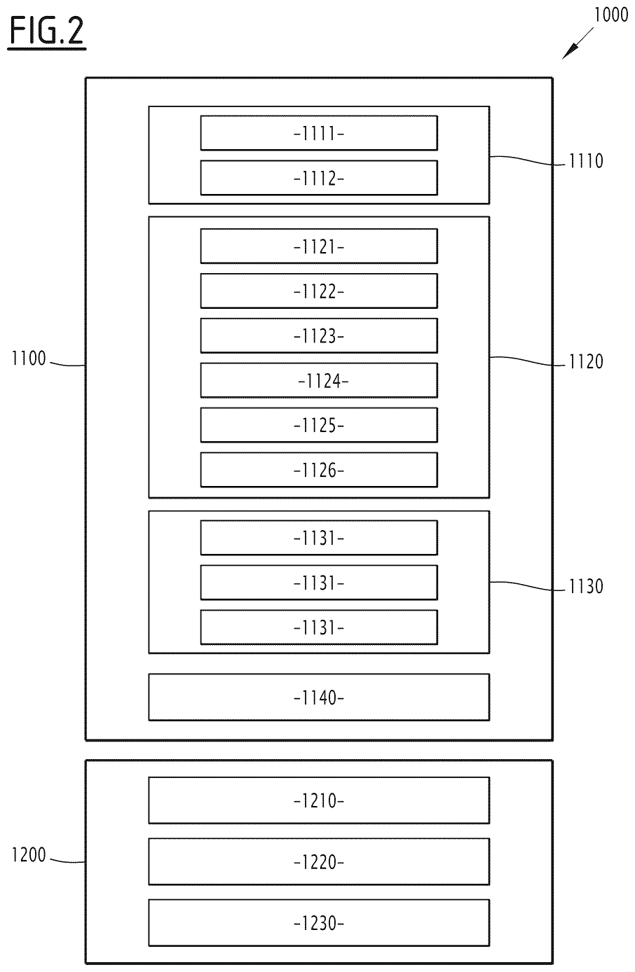

FIG. 2 is a flowchart of a decision aid method according to the invention; and

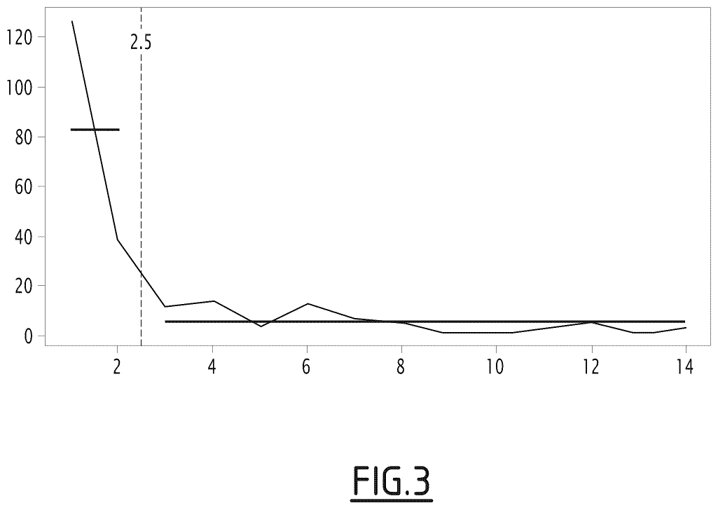

FIG. 3 is a graph representing an example of lemma distribution among pilot speech.

FIG. 1 illustrates an electronic decision aid system 10 for a pilot of an aircraft 12.

The electronic system 10 comprises an electronic device 14 for generating a structured database storing data said to be relevant for the pilot of the aircraft 12, and an electronic interaction device 16 between the pilot of the aircraft 12 and the structured database.

The generation device 14 comprises, for example, a first computer, such as a computer 18. Furthermore, the generation device 14 preferably comprises a display screen 20 and a microphone 22.

The configurations of the generation device 14 will be detailed later with reference to a decision aid method for a pilot of an aircraft, partly implemented by the generation device 14.

The interaction device 16 is preferably included in the aircraft 12. For example, the interaction device 16 comprises a second computer 24, preferably coupled to a display screen 26 and an acquisition means 28, such as a keyboard, a touch surface, or a microphone.

For example, the interaction device 16 is connected to an FMS of the aircraft, or included inside this FMS.

The computers 18, 24 are able to implement a decision aid method for a pilot of an aircraft, which will be described later.

The computers 18, 24 are respectively electronic circuits designed to manipulate and/or transform data represented by electronic or physical quantities in the registers of the computer and/or memories into other similar data corresponding to physical data in the memory registers or other types of display devices, transmission devices, or storage 10 devices.

As specific examples, the computers 18, 24 are each made in the form of a programmable logic component, such as an FPGA (Field Programmable Gate Array), or an integrated circuit, such as an ASIC (Application Specific Integrated Circuit).

Alternatively, when the method is implemented in the form of one or more software programs, i.e., in the form of a computer program, also called a computer program product, it is also capable of being recorded on a set of computer program products (not shown) readable by a computer.

The computer program products are, for example, respectively capable of being stored on a medium capable of storing electronic instructions and being coupled to a bus of a computer system. For example, said medium is an optical disk, a magneto-optical disk, a ROM memory, a RAM memory, any type of non-volatile memory (for example, FLASH or NVRAM), or a magnetic card.

The decision aid method 1000 for a pilot of the aircraft 12 will now be described with reference to FIG. 2.

The method 1000 comprises a phase 1100 of generating a structured database and a phase of interaction 1500 between the pilot and the structured database.

Preferably, initially, during the obtaining phase 1110, a plurality of pilots are performing tasks on a flight simulator.

The generation phase 1100 comprises an obtaining step 1110 of a plurality of texts corresponding to pilot responses in the context of a transfer of responsibility, from one pilot to another, during a flight simulation of the aircraft.

Preferably, the obtaining step 1110 comprises, for each of said pilots, a sub-step of acquisition 1111 of audio tracks corresponding to the speech of pilots performing tasks on a simulator and to whom a list of questions is posed.

To this end, the computer 18 communicates, for example, the list of questions via the display screen 20, to each pilot.

Preferably, the list of questions comprises a first group of questions related to the takeover of the cockpit by a pilot, and a second group of questions related to the transfer of the cockpit to another pilot.

According to an example, the first group of questions comprises the following questions:
E1: What information at your disposal, via the simulator, was useful for you to perform your task?
E2: What additional information, via the simulator, would you have liked to have at your disposal to successfully complete your task?
E3: What information at your disposal, via the simulator, seemed useless to you?

Preferably, questions E2 and E3 are asked during the transfer of the task to another pilot.

In optional addition or alternatively in this example, the second group of questions comprises the following questions:
S0: What information do you transmit to a pilot who must continue to successfully complete your task?
S1: What additional information would you have liked to communicate during your transfer?
S2: What information could you have refrained from transmitting during the transfer?

Preferably, question S0 is asked just before the previous pilot performs their task transfer with the next pilot, questions S1 and S2 being preferably asked a posteriori, i.e., a few minutes or hours after this transfer.

These questions make it possible to evaluate the information that is most relevant and useful jointly to both pilots during the transfer.

During the acquisition sub-step 1111, the responses from the pilots are, for example, acquired by the generation device 14 via the microphone 22.

Metadata is preferably added to each audio track. The metadata comprises the reference of the question corresponding to this audio track, i.e., E1, E2, E3, S0, S1, S2. This is called labeling.

The obtaining step 1110 preferably comprises a sub-step 1112 of converting each audio track into a respective text file.

To this end, the computer 18 preferably applies an autonomous transcription model to each audio track, such as the “Whisper-timestamped” model as described in the article Computing and visualizing dynamic time warping alignments in R: The dtw package by Giorgino T. This model presents very good transcription quality and is able to provide a confidence quantifier in the transcription for each transcribed word in the text file.

Optionally, during the conversion sub-step 1112, the generation device 14 displays each text file and receives validation and/or correction instructions from a third-party operator. The generation device 18 makes the required corrections if necessary.

The generation phase 1100 then comprises a data extraction step 1120, with the data being referred to relevant data, from the text files.

To this end, the extraction step 1120 preferably comprises a division sub-step 1121, during which each text file, corresponding to the responses to question S0, is divided into smaller word sets, such as sentences or groups of sentences forming a paragraph. This sub-step facilitates subsequent processing while preserving the general semantics of the speech.

Optionally, the extraction step 1120 comprises a sorting sub-step 1122 during which the computer 18 removes, in each word set, empty words, also called “tool words” or “stop-words,” such as definite or indefinite pronouns, adverbs, or conjunctions.

The extraction step 1120 then preferably comprises a parsing sub-step 1123 of the resulting word sets into tokens, also called cyber-tokens. This sub-step is also known by the term “tokenization.”

During the parsing sub-step 1123, the word sets are divided into smaller word groups. For example, the computer 18 applies the N-Gram method, which consists of segmenting the word sets into sequences of consecutive words.

For example, with an N value equal to 2, i.e., the bi-Gram method, the following word set: “right engine temperature above threshold” is converted into the following token sequence: “right engine temperature,” “engine temperature above,” “temperature above threshold.”

As is known, this technique uses, for example, UPOS (Universal Parts Of Speech), which are labels used to categorize words in a text based on their grammatical role. These labels form a standard in the field of natural language processing.

The extraction step 1120 further preferably comprises a reduction sub-step 1124 of each token into a lemma. Each lemma comprises a semantic root of the word(s) of the associated token. This sub-step 1124 is also known by the term “stemming and lemmatization.”

To this end, the computer 18 removes, from each word of each token, the prefixes and suffixes (stemming) and uses a dictionary to determine a root of each word deprived of their prefix/suffix (lemmatization).

According to an example, the token “re-actuation flap” becomes “act flap.”

It is then understood that, among the set of determined lemmas, some are present multiple times. This is particularly related to the reduction sub-step 1124, which makes it possible to form identical lemmas from tokens with similar semantics.

The extraction step 1120 preferably comprises a vectorization sub-step 1125. During this sub-step 1225, the computer 18 converts each lemma into a vector with numerical value. For example, the computer uses techniques, such as Bag of Words and TF-IDF (Term Frequency-Inverse Document Frequency).

Preferably, the extraction step 1120 further comprises a selection sub-step 1126 of a reduced number of lemmas, during which the computer 18 determines, for each lemma or at least a part of the lemmas, a number of occurrences among the speech of different pilots from the audio tracks, based on the metadata. In other words, for each part of the lemmas, the computer 18 determines the number of pilots whose audio track provided a text whose sub-steps 1121 to 1125 led to an identical lemma being formed.

Preferably, the lemmas considered in the selection sub-step 1126 are only the lemmas from the audio tracks corresponding to the responses to question S0.

Lemmas from the speech of several pilots in response to question S0 are hereinafter referred to as “common lemmas.”

FIG. 3 represents an example of the number of common lemmas based on the number of pilots to whom they are common.

In FIG. 3, it is visible that the majority of lemmas come from speech pronounced by a single pilot and decrease with the number of pilots.

Then, during the selection sub-step 1126, the computer 18 determines a breakpoint aimed at reducing the considered lemmas only to the most relevant ones, i.e., those from the speech of a majority of pilots, while maintaining a sufficiently large representativeness. According to this technique, the lemmas meeting this dual constraint of relevance and representativeness are the lemmas from the speech of a number of pilots greater than said breakpoint. The breakpoint is, for example, determined using the Changepoint library of the R software.

In the example shown in FIG. 3, the breakpoint is, for example, determined at the value 2.5. Thus, in this example, the lemmas selected during the selection sub-step 1126 are the lemmas from the speech of at least 3 pilots, and preferably from responses to question S0, i.e., the task transfer between the two pilots.

These selected lemmas correspond to the data selected by the extraction step and are hereinafter called taxons.

The generation phase 1100 then comprises a step 1130 of generating the structured database from the data extracted during the extraction step 1120, i.e., preferably the taxons.

To this end, the generation step 1130 comprises a classification sub-step 1131 of the taxons in a predetermined taxonomy structure.

A taxonomy is a hierarchical classification of different entities of interest (for example, of a company, an organization, or an administration), used to classify documents, digital assets, and other information.

The taxonomy structure is, for example, derived from business expertise and integrated into the computer 18 prior to the implementation of the method 1000.

The taxonomy structure comprises, for example, the following classes: What, Why, How, and ActRel, which characterize the relief activities.

The classification of taxons in the taxonomy structure is, for example, carried out in a known manner, using the Protégé software as described in the article The protégé project: A look back and a look forward by Musen, M. A. (2015).

As an example, each taxon is classified into the different classes based on a similarity between the taxon and the classes. To this end, a natural language processing tool, also called an NLP (Natural Language Programming) tool, is able to assign each taxon to a respective class. Such a tool is preferably trained beforehand on already performed classification examples related to the concerned domain.

It is then understood that the taxonomy data are the taxons from the extraction step 1120.

The generation step 1130 further preferably comprises a determination sub-step 1132, for each taxon, of importance indicators in the taxonomy.

For example, the importance indicators comprise a relevance score SP and more preferably also a frequency of occurrence FS0 of the taxons in response to question S0, and a TF-IDF score.

To this end, the computer 18 determines, for example, for each respective taxon, the frequency of occurrence FS0 using, for example, a Large Language Model, or LLM, such as the MistralAI model.

For this, the model preferably uses the numerical value vectors from the vectorization sub-step 1125 to compare them.

The model then generates, for each taxon, a counter that is incremented when the text in response to question S0 comprises words with semantics comparable to that/those of the taxon. This counter is then normalized by the number of occurrences of each taxon in the responses to question S0, thus forming the frequency of occurrence FS0 of the considered taxon.

In optional addition, the computer determines the TF-IDF score of each taxon.

The TF-IDF score is a quantifier of the frequency of occurrence of the taxon in the responses to question S0. In particular, the TF-IDF score is, for example, the product of the frequency of occurrence FS0 of the taxon in the responses to question S0, and the logarithm of the quotient between the number of responses to question S0 collected and the number of responses to question S0 wherein the taxon appears at least once.

According to a particular embodiment, the TF-IDF score of each taxon is determined during the vectorization sub-step 1125 since this vectorization is carried out using known Bag of Words and TF-IDF techniques. Indeed, these techniques make it possible, in addition to producing numerical value vectors for each taxon, to provide for each taxon a quantifier of the importance of each taxon relative to others in the set of texts from the responses to question S0.

To calculate the relevance score, according to an example, a request comprising question S1, question S2, the responses from the pilots to questions S1 and S2, as well as context elements, is transmitted to the LLM model.

In particular, the request is, for example, formulated as follows:
“You are a conversation aid assistant between two pilots during a relief activity. The two pilots, respectively called the incoming pilot and the outgoing pilot, exchange information during this transfer of instructions. At the end of the exchange, the incoming pilot asks the following questions to the outgoing operator:”
question S1
question S2
“To which the outgoing pilot responds:”
response to question S1,
response to question S2,
“As a conversation aid assistant, rely only on the given context. Among the taxons present in the taxonomy, which ones are to be transmitted on one side and which ones are not to be transmitted on the other, to the incoming pilot, so that they can resume the activity?”

To perform such processing, the LLM model uses, for example, the numerical value vectors from the vectorization sub-step 1125 to perform its processing.

The LLM model is then able to provide, for each taxon, a frequency of occurrence FS1 in the responses to questions S1, and a frequency of occurrence FS2 in the responses to questions S2.

The computer 18 then preferably determines, for each taxon, the relevance score according to the following formula:

$$S P = FS 0 + α ( F S 1 - F S 2 ) \qquad [ MATH 1 ]$$

where FS0 is the frequency of occurrence of the taxon in the response to question S0, and
α is the TF-IDF score of the taxon.

It is then understood that the taxons with the highest relevance score are the taxons relating to the information that the greatest number of pilots would have liked to transmit during their transfer (question S1). Conversely, the taxons with the lowest relevance score are those relating to information they could have refrained from transmitting during the transfer (question S2).

Optionally, the request further comprises the responses to questions E1, E2, and E3.

The LLM model is then able to also provide, for each taxon, the frequency of occurrence FE1 in the responses to questions E1, and the frequency of occurrence FE2 in the responses to questions E2.

The aforementioned formula of the relevance score SP would then be modified as follows:

$$S P = S 0 + α ( FS 1 + FE 1 + FE 2 - FS 2 - FE 3 ) \qquad [ MATH 2 ]$$

According to this optional addition, it is then understood that the taxons with the highest relevance score SP are the taxons relating to the information that the greatest number of pilots also found useful or would also have liked to have (question E2), Conversely, the taxons with the lowest relevance score are those relating to information also absent from the responses to questions E1, E2, S1 but relating to information that the pilots also deemed useless (question E3).

Optionally, the generation phase 1100 further comprises a filtering step 1140 of the structured database, during which the computer 18 removes from the structured database the taxons with a relevance score SP below a first threshold or with a TF-IDF score below a second threshold.

Indeed, this step makes it possible to reduce the size of the structured database by removing, for example, the data corresponding to information that the pilots considered superfluous during the transfer, for example, in response to question S2.

Thus, this step allows the size of the structured database to be further limited to the most relevant data.

At the end of the generation phase 1100, the generation device 14 has generated the structured database including the most relevant data for the transfer of information between two pilots. Such a structured database is therefore called CROP (Common Relevant Operating Picture).

It is understood that the structured database is an ontology insofar as it presents a taxonomy structure while being enriched by respective indicators of the data it contains. In particular, these respective indicators reflect semantic characteristics of the data, transcribing the semantics of the texts from which the structured database is generated. It is then also called a knowledge base.

The generated structured database is then integrated into the interaction device 16, preferably before the flight of the aircraft 12.

During the flight of the aircraft, a pilot of the aircraft wishes to obtain information about the current situation they are facing. This is, for example, done during a pilot change in a long-haul flight, or when the pilot is faced with an unusual situation.

The method then comprises an interaction phase 1200, implemented by the interaction device 16.

The interaction phase 1200 comprises a reception step 1210 of a request from the pilot. The request is preferably received via the acquisition means 28.

The interaction phase 1200 then comprises a determination step 1220 of the data from the structured database that is relevant to the request by comparing the request to the data in the structured database.

The interaction phase 1200 then comprises a transmission step 1230 of the determined data to the pilot, preferably via the display screen 26.

Thus, at the end of the interaction phase, the pilot is aware of the relevant data in the situation they encounter and can deduce the actions to be taken to successfully complete their mission. Furthermore, since only the relevant data is transmitted to the pilot, they do not have to sort through the information communicated to them to deduce the most useful data. This timesaving is essential as it allows the pilot to act quickly and saves them cognitive load that could have led them to make poor decisions regarding the actions to be taken.

1. A decision aid method for a pilot of an aircraft, the method comprising a phase of generating a structured database implemented by an electronic generation device, and a phase of interaction between the structured database and the pilot, implemented by an electronic interaction device integrated into an aircraft cockpit,
the generation phase being implemented prior to the aircraft flight and comprising the following steps:
obtaining a plurality of texts corresponding to pilot responses in the context of a transfer of responsibility, from one pilot to another, during a flight simulation of the aircraft,
extracting data from the obtained texts to form a set of data, called taxons, each taxon comprising a word, or a set of words, related to a characteristic of the cockpit,
generating the structured database by classifying the taxons in a predetermined database structure, and determining a set of quantified importance indicator(s) for each taxon by comparing each taxon to the obtained texts,
the interaction phase being implemented during the aircraft flight and comprising the following steps:
receiving a request from the pilot,
determining the data from the structured database that are relevant to the request by comparing the request to the data in the structured database,
transmitting the determined data to the pilot.

2. The method according to claim 1, wherein the obtaining step comprises the following sub-steps:
acquisition of audio tracks comprising the speech of pilots performing tasks on a simulator and to whom a list of questions is posed, and
conversion of each audio track into a respective text file.

3. The method according to claim 2, wherein the list of questions comprises a first group of questions related to the takeover of the cockpit by a pilot, and a second group of questions related to the transfer of the cockpit to another pilot.

4. The method according to claim 1, wherein the set of quantified importance indicator(s) comprises at least one relevance score whose value is based on the frequency of occurrence of said taxon in the texts,
the relevance score being greater the more the corresponding taxon is presented as important in the obtained texts during the obtaining step.

5. The method according to claim 4, wherein the list of questions comprises a first group of questions related to the takeover of the cockpit by a pilot, and a second group of questions related to the transfer of the cockpit to another pilot, and wherein the set of quantified importance indicator(s) for each taxon comprises:
a frequency of occurrence of the taxon in a part of the obtained texts,
a TF-IDF score of said taxon resulting from a vectorization of the taxon,
the relevance score of the taxon,
the relevance score of the taxon being calculated from the responses to the questions related to the transfer of the cockpit.

6. The method, according to claim 5, wherein the second group of questions comprises:
a first question asking the pilot for the information they would have liked to transmit,
a second question asking the pilot for the information they would not have liked to transmit,
the relevance score of each taxon depending positively on the frequency of occurrence of said taxon in the response to the first question, and negatively on the frequency of occurrence of said taxon in the response to the second question.

7. The method according to claim 1, wherein the step of extracting terms from the texts comprises the following sub-steps:
division of each text into a plurality of smaller word sets compared to the text,
parsing of the word sets into tokens each comprising a smaller number of words than the word sets,
for each token, reduction of said token to a lemma comprising a semantic root of the word(s) of the token,
selection, among the formed lemmas, based on the frequency of occurrence of these lemmas among the texts from different pilots,
the selected lemmas forming the set of data, called taxons.

8. The method according to claim 1, wherein the list of questions comprises a question asking the pilot to transmit the information they consider important for the transfer to the other pilot, during the selection sub-step of the extraction step, and the lemma taxons are further selected only among the lemmas from the response texts to said question.

9. The method according to claim 1, wherein the generation phase further comprises a filtering step, during which the taxons whose set of quantified importance indicator(s) do not meet a respective criterion are removed from the structured database.

10. A set of non-transitory computer program products comprising software instructions which, when executed by computers, implement the decision aid method according to claim 1.

11. A decision aid system for a pilot of an aircraft, the system comprising a device for generating a structured database, and an interaction device between the structured database and the pilot, the electronic interaction device being integrated into an aircraft cockpit,
the generation device being configured to, prior to the aircraft flight:
obtain a plurality of texts corresponding to pilot responses in the context of a transfer of responsibility, from one pilot to another, during a flight simulation of the aircraft,
extract data from the obtained texts to form a set of data, called taxons, each taxon comprising a word, or a set of words, related to a characteristic of the cockpit,
generate the structured database by classifying the taxons in a predetermined database structure, and determining a set of quantified importance indicator(s) for each taxon by comparing each taxon to the obtained texts,
the interaction device being configured to, during the aircraft flight:
receive a request from the pilot,
determine the data from the structured database that is relevant to the request by comparing the request to the data in the structured database,
transmit the determined data to the pilot.
